(19) United States
(12) Patent Application Publication
(10) Pub. No.: US 2011/0051169 A1
(43) Pub. Date: Mar. 3, 2011

(54) Image Processing Device

(75) Inventor: Kanji TAKEMATSU, Minamiminowa-mura (JP)

(73) Assignee: Seiko Epson Corporation, Tokyo (JP)

(21) Appl. No.: 12/870,590

(22) Filed: Aug. 27, 2010

(30) Foreign Application Priority Data
Aug. 28, 2009 (JP) 2009-198862

(51) Int. Cl. G06F 3/12; H04N 1/40

(52) U.S. Cl. 358/1.13; 358/448

(57) ABSTRACT

An image processing device includes an input section to which scan data is input, a text identifying section which identifies whether the scan data is text document-based, an output format identifying section which identifies whether the scan data is ink jet output-based upon the text identifying section identifying the scan data as being text document-based, and an image processing section which carries out different kinds of image processing on the scan data in accordance with a result identified by the output format identifying section.

### BACKGROUND

1. Technical Field

The present invention relates to an image processing device.

2. Related Art

An ordinary copying machine carries out image processing for scan data in various ways so as to produce output data and to make a copy, as disclosed in, e.g., JP-A-2007-266783. Such a copying machine carries out similar image processing for scan data regardless of a type of a scanned document.

Upon copying an ink jet output document, however, the ordinary copying machine can cause blurring in a conspicuous manner in some cases.

### SUMMARY

An advantage of some aspects of the invention is that blurring caused to a copy of an ink jet output document can be made inconspicuous.

According to an aspect of the invention, an image processing device includes an input section to which scan data is input, a text identifying section which identifies whether the scan data is text document-based, an output format identifying section which identifies whether the scan data is ink jet output-based upon the text identifying section identifying the scan data as being text document-based, and an image processing section which carries out different kinds of image processing on the scan data in accordance with a result identified by the output format identifying section.

### BRIEF DESCRIPTION OF THE DRAWINGS

The invention will be described with reference to the accompanying drawings, wherein like numbers reference like elements.

FIG. 1 schematically shows a configuration of an image processing device of an embodiment of the invention.

FIG. 2 shows a hardware configuration of a block type identifying circuit 107 of the embodiment of the invention.

FIG. 3 is a flowchart for explaining a block type identifying process.

FIG. 4A shows an exemplary ink jet output text document.

FIG. 4B shows an exemplary laser output text document.

FIG. 4C shows an enlarged exemplary ink jet output block.

FIG. 4D shows an enlarged exemplary laser output block.

FIG. 5A shows an exemplary method for image processing.

FIG. 5B shows another exemplary method for image processing.

### DESCRIPTION OF EXEMPLARY EMBODIMENTS

An exemplary embodiment of the invention will be explained with reference to the drawings as follows.

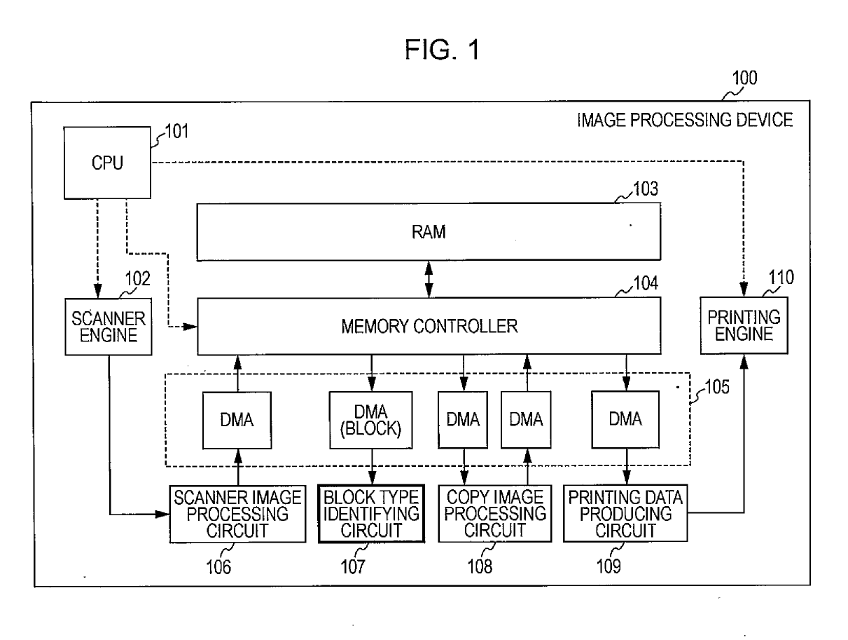

FIG. 1 schematically shows a configuration of an image processing device 100 to which the embodiment of the invention is applied.

The image processing device 100 is, e.g., a copying machine. The image processing device 100 scans a document fixed on paper, etc. so as to produce printing data or an electronic file in a particular format.

As shown in FIG. 1, the image processing device 100 has a CPU 101, a scanner engine 102, a RAM 103, a memory controller 104, a DMA (Direct Memory Access) section 105, a scanner image processing circuit 106, a block type identifying circuit 107, a copy image processing circuit 108, a printing data producing circuit 109 and a printing engine 110. The configuration of the image processing device 100 is not limited to the above as a matter of course. The scanner engine 102 corresponds to an input section. The block type identifying circuit 107 corresponds to a text identifying section and an output format identifying section. The copy image processing circuit 108 and the printing data producing circuit 109 correspond to an image processing section. The printing engine 110 corresponds to a printing section.

The CPU 101 is an arithmetic device which implements various functions of the image processing device 100 by controlling other units. The CPU 101 implements various processes by loading the RAM 103 with proper programs stored in a memory such as a ROM (not shown) and running the programs.

The CPU 101 scans a document by, e.g., controlling the scanner engine 102. Further, the CPU 101 performs a process for identifying a document type and various kinds of image processing on scan data (input image data) of the document output from the scanner engine 102 by controlling the scanner image processing circuit 106, the block type identifying circuit 107, the copy image processing circuit 108 and the printing data producing circuit 109.

For the document type identifying process, the CPU 101 sets a horizontal edge level HL, a vertical edge level VL and a brightness level BL, which will be described later, to the block type identifying circuit 107. Further, the CPU 101 divides scan data (image data on which the scanner image processing circuit 106 have performed various kinds of image processing) of one page into a particular number of blocks, and transfers the scan data to the block type identifying circuit 107 on a block-by-block basis. Then, the CPU 101 obtains from the block type identifying circuit 107 the total number of a block type (the total number of blocks for each of the block types) identified for each of the blocks (“text and ink jet output block” A1, “text and non-ink jet output block” B1, “non-text block” C1). Moreover, the CPU 101 identifies a document type (“text and ink jet output document” A2, “text and non-ink jet output document” B2, “non-text document” C2) of every page on the basis of the obtained total number of each of the block types (A1, B1, C1).

The text block described here is a block including a text (e.g., a block in which the number of white pixels is greater than a certain threshold). The non-text block is a block including a picture, a figure, etc. (e.g., a block in which the number of white pixels is smaller than a certain threshold). Further, the ink jet output block is a block printed by means of ink jet printing (e.g., a block in which a ratio of the number of pixels on a horizontal edge to the number of pixels on a vertical edge is close to one). The non-ink jet output block is a block printed by means of laser printing, etc. (e.g., a block in which a ratio of the number of pixels on a horizontal edge to the number of pixels on a vertical edge is biased).

Further, the “text and ink jet output document” A2 is a document including a text and printed by means of ink jet printing (e.g., a document for which the total number of the blocks of the block type A1 is greatest in one page). Further, the “text and non-ink jet output document” B2 is a document including a text and printed by means of laser printing, etc. (e.g., a document for which the total number of the blocks of the block type B1 is greatest in one page). Further, the “non-text document” C2 is a page including a picture, a figure, etc. (e.g., a document for which the total number of the blocks of the block type C1 is greatest in one page).

Further, the CPU 101 carries out printing by controlling the printing engine 110. Further, the CPU 101 produces an electronic file on the basis of the scan data on which various kinds of image processing have been performed.

Various programs and data are stored in the RAM 103. Image data on which the scanner image processing circuit 106 have performed image processing, image data on which the copy image processing circuit 108 have performed image processing (color conversion, smoothing, edge stressing, etc.), an electronic file produced by the CPU 101, e.g., are stored in the RAM 103.

The memory controller 104 exchanges data to and from the RAM 103 (a reading process, a writing process) as directed by the respective units (the CPU 101, the DMA section 105).

The DMA section 105 is controlled by the scanner image processing circuit 106, the block type identifying circuit 107, the copy image processing circuit 108 and the printing data producing circuit 109 individually, so that data can be transferred between each of the units (106-109) and the RAM 103 without being controlled by the CPU 101.

The scanner engine 102 is a unit which reads a document and outputs digitized image data (e.g., RGB image data). The scanner engine 102 has, e.g., an ADF (Auto Document Feeder), a light source, a carriage, a motor for scanning, a CCD line sensor, an AFE (Analog Front End), etc.

The scanner engine 102 irradiates every page (every sheet) of a document while letting the ADF transport the document, so as to guide light reflected by the document to the CCD line sensor provided with filters of red (R), green (G) and blue (B). Then, the scanner engine 102 converts analog data of the respective RGB colors which have been read into digital signals, and outputs the digital signals to the scanner image processing circuit 106 as image data having gradation values of the respective RGB colors for each of the pixels.

The scanner image processing circuit 106 is a circuit which performs various kinds of image processing on the image data output from the scanner engine 102. The scanner image processing circuit 106 receives image data of every page of the document, and performs, e.g., a shading correction process, an inter-lines correction process, a scaling up/down process, etc. Then, the scanner image processing circuit 106 stores the image data on which the various kinds of image processing have been performed in the RAM 103 via the DMA section 105 and the memory controller 104.

The block type identifying circuit 107 identifies the block type (A1, B1, C1) of each of the blocks into which the scan data (the image data on which the scanner image processing circuit 106 has performed various kinds of image processing) has been divided.

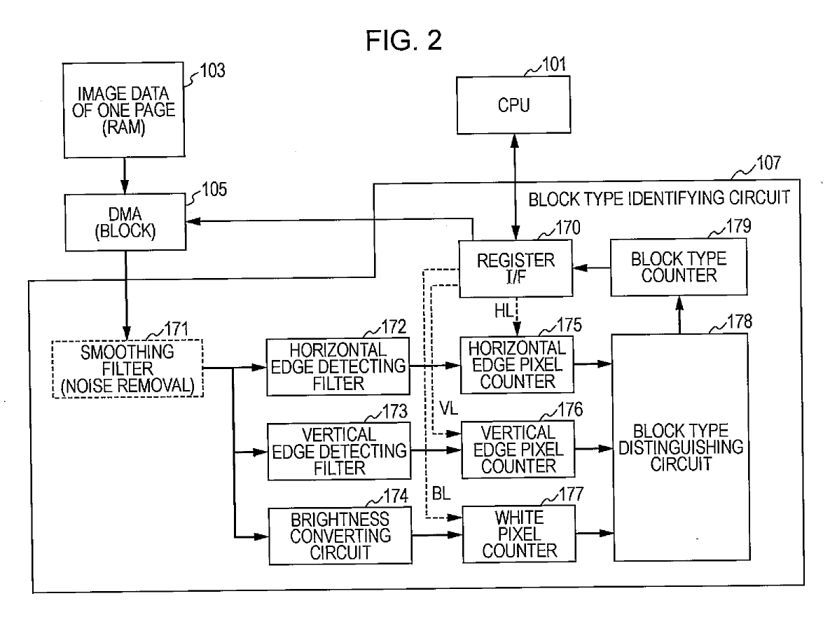

The block type identifying circuit 107 will be explained in more detail with reference to FIG. 2. FIG. 2 shows a hardware configuration of the block type identifying circuit 107 to which the embodiment of the invention is applied.

As shown in FIG. 2, the block type identifying circuit 107 has a register interface (I/F) 170, a smoothing filter 171, a horizontal edge detecting filter 172, a vertical edge detecting filter 173, a brightness converting circuit 174, a horizontal edge pixel counter 175, a vertical edge pixel counter 176, a white pixel counter 177, a block type distinguishing circuit 178 and a block type counter 179.

The register I/F 170 sets a specified horizontal edge level HL to the horizontal edge pixel counter 175 as requested by the CPU 101. The horizontal edge level HL described here is a threshold for identifying whether each of pixels in one page (in one block) is an edge pixel in the horizontal direction. Further, the register I/F 170 sets a specified vertical edge level VL to the vertical edge pixel counter 176. The vertical edge level VL described here is a threshold for identifying whether each of pixels in one page (in one block) is an edge pixel in the vertical direction.

Further, the register I/F 170 sets a specified brightness level BL to the white pixel counter 177 as requested by the CPU 101. The brightness level BL described here is a threshold for identifying whether each of pixels in one page (in one block) is a white pixel.

The register I/F 170 obtains from the block type counter 179 the total number of blocks included in one page for each of the block types (described later) as requested by the CPU 101, and outputs the obtained respective total number of blocks to the CPU 101.

Further, the register I/F 170 activates the DMA section 105 (the DMA connected to the block type identifying circuit 107), and transfers image data (pixel data) of one page on a block-by-block basis without being controlled by the CPU 101.

The smoothing filter 171 is a circuit which receives image data (pixel data) output from the RAM 103 via the DMA section 105 on a block-by-block basis, and carries out a smoothing filtering operation for each of the pixels. Owing to the smoothing filtering operation, a noise component included in the image data of each of the input pages can be less possibly detected as a false edge pixel. The smoothing filter 171 outputs the filtered image data (pixel data) to the horizontal edge detecting filter 172, the vertical edge detecting filter 173 and the brightness converting circuit 174.

The horizontal edge detecting filter 172 is a circuit which performs a filtering operation for detecting an edge in the horizontal direction for each of the pixels and outputs an edge value. As the filter, e.g., a Sobel filter or a Prewitt filter which finds a difference between each of the pixels and its adjacent pixel can be employed. The horizontal edge detecting filter 172 provides the horizontal edge pixel counter 175 with an edge value of the filtered pixel data.

The vertical edge detecting filter 173 is a circuit which performs a filtering operation for detecting an edge in the vertical direction for each of the pixels and outputs an edge value. As the filter, e.g., a Sobel filter or a Prewitt filter which finds a difference between each of the pixels and its adjacent pixel can be employed. The vertical edge detecting filter 173 provides the vertical edge pixel counter 176 with an edge value of the filtered pixel data.

The brightness converting circuit 174 is a circuit which converts an RGB gradation value of each of the input pixel data into a brightness value L indicating brightness. The brightness converting circuit 174 calculates the brightness value L by carrying out an operation in accordance with a proper converting equation (e.g., a converting equation: L=0.2989×R+0.5866×G+0.1145×B). The brightness converting circuit 174 provides the white pixel counter 177 with the calculated brightness value L.

The horizontal edge pixel counter 175 is a circuit which counts the number of edge pixels in the horizontal direction. The horizontal edge pixel counter 175 identifies whether the edge value of each of the pixels output from the horizontal edge detecting filter 172 is greater than a certain threshold (the horizontal edge level HL being set). Further, the horizontal edge pixel counter 175 counts the pixels of the edge values greater than the threshold as horizontal edge pixels. Then, the horizontal edge pixel counter 175 provides the block type distinguishing circuit 178 with the number of the horizontal edge pixels included in one block.

The vertical edge pixel counter 176 is a circuit which counts the number of edge pixels in the vertical direction. The vertical edge pixel counter 176 identifies whether the edge value of each of the pixels output from the vertical edge detecting filter 173 is greater than a certain threshold (the vertical edge level VL being set). Further, the vertical edge pixel counter 176 counts the pixels of the edge values greater than the threshold as vertical edge pixels. Then, the vertical edge pixel counter 176 provides the block type distinguishing circuit 178 with the number of the vertical edge pixels included in one block.

The white pixel counter 177 is a circuit which counts the number of white pixels. The white pixel counter 177 identifies whether the brightness value of each of the pixels output from the brightness converting circuit 174 is greater than a certain threshold (the brightness level EL being set). Further, the white pixel counter 177 counts the pixels of the brightness values greater than the threshold as white pixels. Then, the white pixel counter 177 provides the block type distinguishing circuit 178 with the number of the white pixels included in one block.

The block type distinguishing circuit 178 is a circuit which distinguishes the block type (A1, B1, C1) of the image data (pixel data) of one block.

The block type distinguishing circuit 178 identifies whether the number of the horizontal edge pixels output from the horizontal edge pixel counter 175 or the number of the vertical edge pixels output from the vertical edge pixel counter 176 is greater than a certain threshold (e.g., the number of pixels corresponding to ten percent of the number of all the pixels forming one block). The block type distinguishing circuit 178 identifies as well whether the number of the white pixels output from the white pixel counter 177 is greater than a certain threshold (e.g., the number of pixels corresponding to 30 percent of the number of all the pixels forming one block). Then, upon identifying one of the number of the horizontal edge pixels and the number of the vertical edge pixels as being greater than the threshold and identifying the number of the white pixels as being greater than the threshold, the block type distinguishing circuit 178 identifies the relevant block as a text block. Meanwhile, upon identifying both the number of the horizontal edge pixels and the number of the vertical edge pixels as being smaller than the threshold, or identifying the number of the white pixels as being smaller than the threshold, the block type distinguishing circuit 178 identifies the relevant block as a “non-text block” C1.

Upon identifying the relevant block as a text block, the block type distinguishing circuit 178 identifies whether a ratio R of the number of the horizontal edge pixels output from the horizontal edge pixel counter 175 to the number of the vertical edge pixels output from the vertical edge pixel counter 176 (e.g., the number of the horizontal edge pixels/the number of the vertical edge pixels) is close to one (e.g., 0.8<ratio R<1.2) or biased (e.g., ratio R≦0.8, ratio R≧1.2). Then, upon identifying the ratio R as being close to one, the block type distinguishing circuit 178 regards the pixels included in one block as having random edge directions, and identifies the relevant block as a “text and ink jet output block” A1. Meanwhile, upon identifying the ratio R as being biased, the block type distinguishing circuit 178 regards the pixels included in one block as having a definite direction, and identifies the relevant block as a “text and non-ink jet output block” B1.

Then, the block type distinguishing circuit 178 distinguishes a block type of every block similarly as described above, and provides the block type counter 179 with a signal (data) indicating the identified block type (A1, B1, C1).

The block type counter 179 is a circuit which counts the number of blocks belonging to each of the block types (A1, B1, C1) in one page. The block type counter 179 identifies the block type output from the block type distinguishing circuit 178 for every block, and counts the number of blocks belonging to a same block type. Then, the block type counter 179 individually stores the total number of the blocks belonging to the “text and ink jet output block” A1, the total number of the blocks belonging to the “text and non-ink jet output block” B1, the total number of the blocks belonging to the “non-text block” C1 in memory, and outputs the respective total numbers as requested by the register I/F 170.

The configuration of the block type identifying circuit 107 is not limited to the above as a matter of course. The block type identifying circuit 107, e.g., can lack the smoothing filter 171.

Return to FIG. 1 for continuing the explanation. The copy image processing circuit 108 is a circuit which performs various kinds of image processing on the image data output from the scanner image processing circuit 106 for copying the image data. The copy image processing circuit 108 obtains from the RAM 103 the image data of the respective pages on which various kinds of image processing have been performed by the scanner image processing circuit 106, and performs, e.g., a color conversion process, a smoothing process, an edge stressing process, etc. Then, the copy image processing circuit 108 stores the image data on which the various kinds of image processing have been performed in the RAM 103 via the DMA controller 105, the memory controller 104.

Further, the copy image processing circuit 108 changes a method for image processing as to the smoothing process, the edge stressing process, etc. in accordance with the document type (A2, B2, C2) of every page identified by means of the above process for identifying the document types.

The printing data producing circuit 109 is a circuit which performs various correction processes on the image data output from the copy image processing circuit 108, and produces printing data which can be printed by the printing engine 110. The printing data producing circuit 109 obtains from the RAM 103 the image data of every page on which the various kinds of image processing have been performed by the copy image processing circuit 108, and performs, e.g., a screening process, a binary encoding process, etc. Then, the printing data producing circuit 109 produces printing data on the basis of the image data on which the various correction processes have been performed and provides the printing engine 110 with the printing data.

Further, the printing data producing circuit 109 changes a method for image processing as to the screening process, the binary coding process, etc. in accordance with the document type (A2, B2, C2) of every page identified by means of the above process for identifying the document types.

The printing engine 110 carries out printing on the basis of the printing data output from the printing data producing circuit 109.

The image processing device 100 to which the embodiment is applied is configured as described above. The configuration of the image processing device 100, however, is not limited to the above. The image processing device 100 can be, e.g., a multifunction printer further having a facsimile function or a scanner device lacking the printing engine 110.

Further, each of the portions described above is separately specified in accordance with main processing functions so that how the image processing device 100 is configured can be easily understood. The invention is never limited depending on how the portions are separately specified or what they are called. The configuration of the image processing device 100 can be more finely classified into a greater number of portions in accordance with the processing functions. Further, one of the portions can be specified in such a way as to perform further more processes. Further, a process of each of the portions can be implemented by one hardware unit or by plural hardware units.

Further, the block type identifying circuit 107 can be implemented by software by means of a proper program run by the CPU 101.

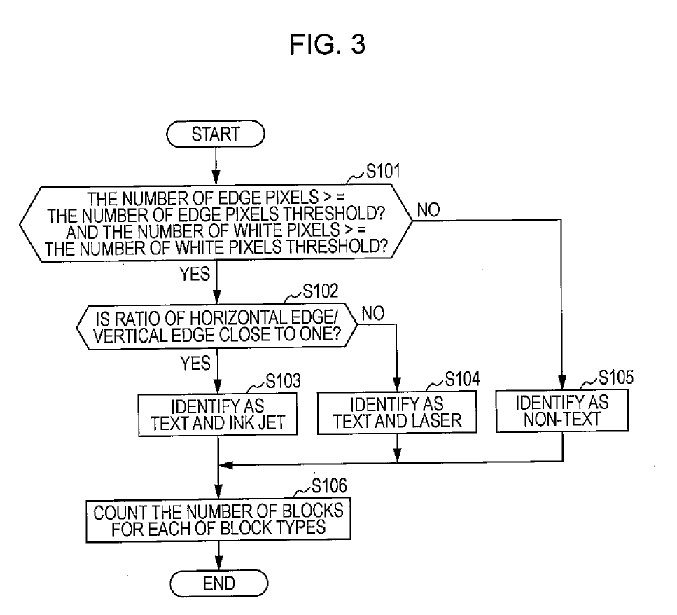

Then, a distinctive operation of the image processing device 100 that is configured as described above will be explained. FIG. 3 is a flowchart for explaining a block type identifying process carried out by the block type identifying circuit 107 of the embodiment.

The block type identifying circuit 107 starts the flow upon, e.g., being directed to identify the block type by the CPU 101.

After the flow starts, the register I/F 170 of the block type identifying circuit 107 transfers image data (pixel data) of one page from the RAM 103, via the DMA section 105, to the smoothing filter 171 on a block-by-block (e.g., 8×8 pixels) basis. Then, as described above, the block type distinguishing circuit 178 is provided with the number of the horizontal edge pixels included in one block via the smoothing filter 171, the horizontal edge detecting filter 172, the horizontal edge pixel counter 175. The block type distinguishing circuit 178 is similarly provided with the number of the vertical edge pixels included in one block via the smoothing filter 171, the vertical edge detecting filter 173, the vertical edge pixel counter 176. Further, the block type distinguishing circuit 178 is provided with the number of the white pixels included in one block via the smoothing filter 171, the brightness converting circuit 174, the white pixel counter 177.

The block type distinguishing circuit 178 identifies whether one of the number of the input horizontal edge pixels and the number of the input vertical edge pixels is greater than a certain threshold (e.g., seven pixels). The block type distinguishing circuit 178 identifies as well whether the number of the input white pixels is greater than a certain threshold (e.g., 20 pixels) (step S101).

Upon identifying both the number of the input horizontal edge pixels and the number of the input vertical edge pixels as being smaller than the threshold, or identifying the number of the input white pixels as being smaller than the threshold at this step (step S101; No), the block type distinguishing circuit 178 shifts the process to a step S105.

If the process shifts to the step S105, the block type distinguishing circuit 178 identifies the block type of the block as “non-text block” C1, and provides the block type counter 179 with a signal (data) indicating the identified block type (step S105).

Meanwhile, upon identifying one of the number of the input horizontal edge pixels and the number of the input vertical edge pixels as being greater than the threshold, and identifying the number of the input white pixels as being greater than the threshold at the step S101 (step S101; Yes), the block type distinguishing circuit 178 shifts the process to a step S102.

If the process shifts to the step S102, the block type distinguishing circuit 178 identifies whether a ratio R of the number of the input horizontal edge pixels to the number of the input vertical edge pixels is close to one (step S102). The block type distinguishing circuit 178, e.g., divides the number of the horizontal edge pixels by the number of the vertical edge pixels so as to calculate the ratio R, and identifies whether the calculated ratio R meets a condition “0.8<ratio R<1.2”.

Upon identifying the ratio R of the number of the horizontal edge pixels to the number of the vertical edge pixels as being close to one at the step S102 (step S102; Yes), the block type distinguishing circuit 178 shifts the process to a step S103. Meanwhile, upon identifying the ratio R of the number of the horizontal edge pixels to the number of the vertical edge pixels as not being close to one at the step S102 (step S102; No), the block type distinguishing circuit 178 shifts the process to a step S104.

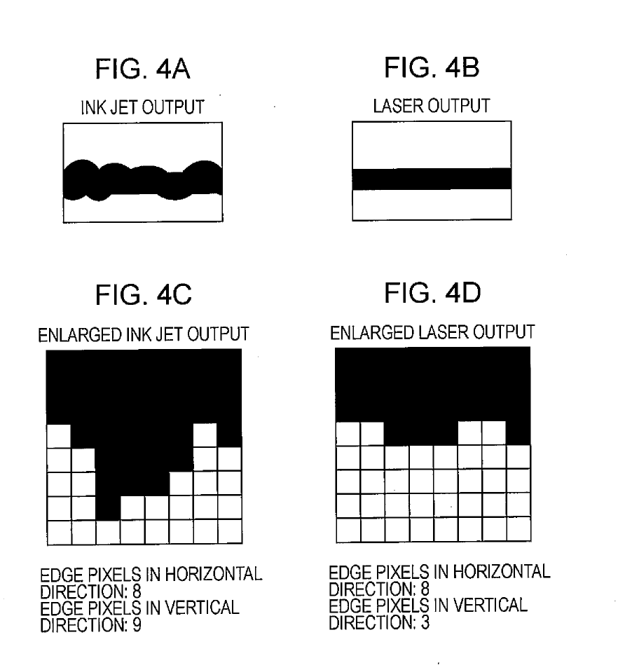

FIG. 4A shows an exemplary ink jet output text document. Further, FIG. 4B shows an exemplary laser output text document. As shown there, the ink jet output text is more likely to cause blurring than the laser output text document in general.

Thus, if the ratio R of the number of the horizontal edge pixels to the number of the vertical edge pixels is close to one, the block type distinguishing circuit 178 of the embodiment regards the document as causing blurring as edge directions are random, and identifies the input block as an ink jet output block.

FIG. 4C shows an enlarged exemplary ink jet output block. Printed and unprinted pixels are shown by black and white squares, respectively. As the exemplary block shown there has eight horizontal and nine vertical edge pixels, the block type distinguishing circuit 178 regards the block as causing blurring and identifies the block as an ink jet output block.

Meanwhile, if the ratio R of the number of the horizontal edge pixels to the number of the vertical edge pixels is not close to one (is biased), the block type distinguishing circuit 178 of the embodiment regards the document as not causing blurring as the edge direction is definite, and identifies the document as a laser output block.

FIG. 4D shows an enlarged exemplary laser output block. Printed and unprinted pixels are shown by black and white squares, respectively. As the exemplary block shown there has eight horizontal and three vertical edge pixels, the block type distinguishing circuit 178 regards the block as not causing blurring and identifies the block as a laser output block.

Thus, if the process shifts to the step S103, the block type distinguishing circuit 178 identifies the block type of the block as “text and ink jet output block” A1, and provides the block type counter 179 with a signal (data) indicating the identified block type (step S103). Meanwhile, if the process shifts to the step S104, the block type distinguishing circuit 178 identifies the block type of the block as “text and non-ink jet output block” B1, and provides the block type counter 179 with a signal (data) indicating the identified block type (step S104).

If the process of one of the steps S103-S105 finishes, the block type identifying circuit 107 shifts the process to a step S106.

If the process shifts to the step S106, the block type counter 179 counts the number of blocks of each of the block types (A1, B1, C1) (step S106). To put it specifically, upon receiving a signal indicating the block type A1 from the block type distinguishing circuit 178, the block type counter 179 incrementally updates a count value for counting the number of the blocks belonging to the block type A1 (note that the initial value is set to 0). Further, upon receiving a signal indicating the block type B1 from the block type distinguishing circuit 178, the block type counter 179 incrementally updates a count value for counting the number of the blocks belonging to the block type B1 (note that the initial value is set to 0). Further, upon receiving a signal indicating the block type C1 from the block type distinguishing circuit 178, the block type counter 179 incrementally updates a count value for counting the number of the blocks belonging to the block type C1 (note that the initial value is set to 0).

Then, the block type counter 179 keeps the incrementally updated count value (the total number) in memory, and finishes the flow.

Incidentally, the above process through the steps S101-S106 is repeated for each of the blocks included in one page. Thus, the block type distinguishing circuit 178 provides the block type counter 179 with one of the block types (A1, B1, C1) for every block (steps S103, S104, S105). Then, every time the block type counter 179 receives one of the block types (A1, B1, C1) of a block, the block type counter 179 incrementally updates the count value of the block type that the block belongs to. Thus, in the end, the block type counter 179 can obtain the total number of the blocks of each of the block types (A1, B1, C1) for the blocks of one page.

Incidentally, each of the processing steps of the flow described above is separately specified in accordance with main processing functions so that the image processing device 100 can be easily understood. The invention is never limited depending on how the processing steps are separately specified or what they are called. The process carried out by the image processing device 100 can be divided into a greater number of processing steps. Further, one of the steps can be specified in such a way as to perform further more processes.

Further, after the process of the above flow finishes, the CPU 101 carries out a process for identifying a document type. To put it specifically, the CPU 101 obtains the total number of the blocks of each of the block types (A1, B1, C1) from the block type counter 179 via the register I/F 170. Then, the CPU 101 specifies the block type of the greatest one of the total numbers of the blocks obtained for the respective block types (A1, B1, C1), and identifies the document type corresponding to the specified block type as the document type of the page. That is, if the total number of the blocks of the block type A1 is greatest in a page, the CPU 101 identifies the document type of the page (scan data) as “text and ink jet output document” A2. Further, if the total number of the blocks of the block type B1 is greatest in a page, the CPU 101 identifies the document type of the page (scan data) as “text and non-ink jet output document” B2. Further, if the total number of the blocks of the block type C1 is greatest in a page, the CPU 101 identifies the document type of the page (scan data) as “non-text document” C2.

After the above process for identifying the document type finishes, the copy image processing circuit 108 obtains the image data stored in the RAM 103 (the image data on which various kinds of image processing have been performed by the scanner image processing circuit 106) via the DMA section 105. Then, the copy image processing circuit 108 carries out different kinds of image processing in accordance with the document types (A2, B2, C2) identified by the process for identifying the document types.

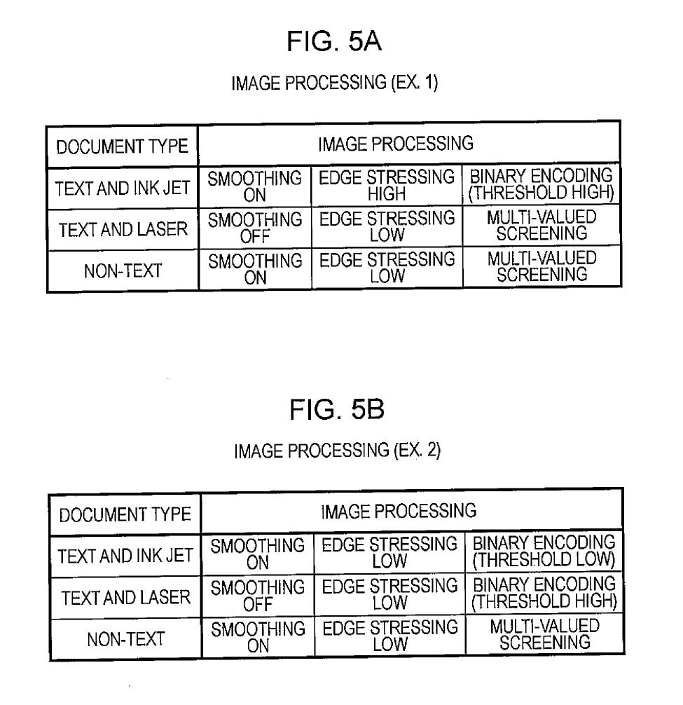

FIG. 5A shows an exemplary method for image processing. Further, FIG. 5B shows another exemplary method for image processing.

As shown in FIG. 5A, e.g., if the document type identified by the process for identifying the document types is “text and ink jet output document” A2, the copy image processing circuit 108 carries out a smoothing process on the image data obtained from the RAM 103, and carries out an edge stressing process of a high strength (higher than a certain strength). Even if a document which is likely to cause blurring such as an ink jet output document is scanned, thereby, a clearly visible copied document can be provided.

Further, if the document type identified by the process for identifying the document types is “text and non-ink jet output document” B2, the copy image processing circuit 108 does not carry out a smoothing process on the image data obtained from the RAM 103, and carries out an edge stressing process of a low strength (lower than a certain strength). If a document which is unlikely to cause blurring such as a laser output document, thereby, a copied document can be provided without degrading visibility.

Further, if the document type identified by the process for identifying the document types is “non-text document” C2, the copy image processing circuit 108 carries out a smoothing process on the image data obtained from the RAM 103, and carries out an edge stressing process of a low strength (lower than a certain strength). Even if a document including an image or a figure is scanned, thereby, a copied document can be provided without degrading visibility.

Further, as shown in FIG. 5B, e.g., if the document type identified by the process for identifying the document types is “text and ink jet output document” A2, the copy image processing circuit 108 can carry out a smoothing process on the image data obtained from the RAM 103, and carry out an edge stressing process of a low strength (lower than a certain strength).

Then, the copy image processing circuit 108 stores the image data on which the image processing has been carried out by means of the above image processing methods in the RAM 103 via the DMA section 105, the memory controller 104.

Here, the CPU 101 image-converts the image data on which the various kinds of image processing have been carried out by the copy image processing circuit 108 in a proper format so as to produce an electronic file. The electronic file produced by the CPU 101 can be, e.g., a PDF (registered trademark) file or a JPEG file. Then, the CPU 101 stores the produced electronic file in the RAM 103, etc. The CPU 101 corresponds to an output section.

Further, in order to print the image data on which the various kinds of image processing have been carried out by the copy image processing circuit 108, the printing data producing circuit 109 obtains the relevant image data from the RAM 103 via the DMA section 105. Then, the printing data producing circuit 109 carries out different kinds of image processing in accordance with the document type (A2, B2, C2) identified by the process for identifying the document types.

As shown in FIG. 5A, e.g., if the document type identified by the process for identifying the document types is “text and ink jet output document” A2, the printing data producing circuit 109 carries out a binary encoding process of a high threshold on the image data obtained from the RAM 103. Even if a document which is likely to cause blurring such as an ink jet output document is scanned, thereby, a clearly visible copied document can be printed.

Further, if the document type identified by the process for identifying the document types is “text and non-ink jet output document” B2, the printing data producing circuit 109 carries out a multi-valued screening process on the image data obtained from the RAM 103. If a document which is unlikely to cause blurring such as a laser output document is scanned, thereby, a copied document can be printed without degrading visibility.

Further, if the document type identified by the process for identifying the document types is “non-text document” C2, the printing data producing circuit 109 carries out a multi-valued screening process on the image data obtained from the RAM 103. Even if a document including an image or a figure is scanned, thereby, a copied document can be printed without degrading visibility.

Further, as shown in FIG. 5B, e.g., if the document type identified by the process for identifying the document types is “text and ink jet output document” A2, the printing data producing circuit 109 can carry out a binary encoding process of a low threshold on the image data obtained from the RAM 103.

Further, if the document type identified by the process for identifying the document types is “text and non-ink jet output document” B2, the printing data producing circuit 109 can carry out a binary encoding process of a high threshold on the image data obtained from the RAM 103.

Then, the printing data producing circuit 109 produces printing data which can be printed by the printing engine 110 from the image data on which the image processing has been carried out by means of the above methods for image processing. The printing data producing circuit 109 transmits the produced printing data to the printing engine 110 so as to print a copied document based on the scan data.

The image processing device 100 carries out the process described above so that ink blurring can be made inconspicuous in a case where an ink jet output document is printed.

Incidentally, the invention is not limited to the above embodiment, and can be variously modified and applied.

The CPU 101 of the embodiment, e.g., carries out the process for identifying the document types described above. The invention, however, is not limited to the above. The process for identifying the document types can be carried out, e.g., by the block type identifying circuit 107. In this case, the block type identifying circuit 107 is provided with an exclusive circuit for carrying out the process for identifying the document types.

Further, as to the embodiment, the block types are identified for all the blocks included in one page. The invention, however, is not limited to the above. The block type identifying circuit 107 can be configured, e.g., to identify the block types for part of the blocks included in one page. The copying process can thereby be speeded up.

The entire disclosure of Japanese Patent Application No.2009-198862, filed Aug. 28,2009 is expressly incorporated by reference herein.

What is claimed is:

1. An image processing device comprising:
an input section to which scan data is input;
a text identifying section which identifies whether the scan data is text document-based;
an output format identifying section which identifies whether the scan data is ink jet output-based upon the text identifying section identifying the scan data as being text document-based; and
an image processing section which carries out different kinds of image processing on the scan data in accordance with a result identified by the output format identifying section.

2. The image processing device according to claim 1, wherein the output format identifying section identifies whether the scan data is ink jet output-based on the basis of a ratio of
the number of horizontal edge pixels included in the scan data to
the number of vertical edge pixels included in the scan data.

3. The image processing device according to claim 1, wherein the text identifying section identifies whether
the scan data is text document-based on the basis of the number of white pixels included in the scan data.

4. The image processing device according to claim 1, further comprising
an output section which outputs in a file format the scan data on which the image processing section carries out the image processing, wherein
upon the output format identifying section identifying the scan data as being ink jet output-based, the image processing section (1) smoothes the scan data and (2) intensifies edge stressing of the scan data.

5. The image processing device according to claim 1, further comprising a printing section which prints the scan data on which the image processing section carries out the image processing, wherein
upon the output format identifying section identifying the scan data as being ink jet output-based, the image processing section (1) smoothes the scan data, (2) intensifies edge stressing of the scan data and (3) binary-encodes the scan data.
